(19) United States
(12) Patent Application Publication
(10) Pub. No.: US 2003/0237042 A1
(43) Pub. Date: Dec. 25, 2003

(54) Document processing device and document processing method

(75) Inventors: Sayori Shimohata, Tokyo (JP); Atsushi Ikeno, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/600,535

(22) Filed: Jun. 23, 2003

(30) Foreign Application Priority Data
Jun. 24, 2002 (JP) JP2002-182883

(51) Int. Cl. G06F 15/00

(52) U.S. Cl. 715/500

(57) ABSTRACT

A document processing device for processing a set having, as elements, a plurality of documents including character information includes a theme information generating unit for extracting the commonality of the character information of the respective documents in the set to generate theme information which is a document expressing common semantic contents being common in the entire set. In this document processing device, the theme information generating unit executes a predetermined generating procedure on the basis of the plurality of documents in the set to generate the theme information as a new document, or the theme information generating unit selects documents having a commonality in character information in advance to constitute the set, selects one document from the plurality of documents in the set depending on a predetermined selecting procedure, and sets the selected document as the theme information to generate the theme information.

### BACKGROUND OF THE INVENTION

The invention relates to a document processing device and a document processing method, for example, which are suitably applied to a case in which a plurality of texts of the same kind which are obtained as results obtained by searching a text database by using the same keyword as a search key are processed and displayed.

### DESCRIPTION OF THE RELATED ART

As a conventional device of this type, a device described in Reference 1: Japanese Patent Laid-open Publication No. 9-231238 is known.

A process executed by the display device according to Reference 1 is constituted by the dividing step of dividing a text set into a plurality of groups automatically, the generating step of generating pieces of theme classification information for expressing the attributes of the groups obtained by the dividing step, and the display step of displaying the pieces of theme classification information of the groups obtained by the generating step such that the pieces of theme classification information are sectionalized.

The theme classification information is information corresponding to the contents of a text and indicates a combination of keywords or a short sentence.

The display device of Reference 1 has the step of calculating the degree of adaptation between the group and a search condition and the degree of attribution of each text in a group to the group. The display device can also select the display order of the groups or the texts according to the values.

However, in the above display device, on the basis of pieces of theme classification information of the groups presented in units of the groups, i.e., a combination of keywords or a short sentence, the contents of texts included in the groups must be determined. In many cases, it is difficult to precisely determine the contents of texts (or outline of a group) included in the group on the basis of the combination of keywords or the short sentence. For this reason, as a result, a user cannot check a search result without reading the respective texts included in the group, and cannot also know the outline of the group.

Therefore, a long time and a trouble are required to check the search result and to know the outline of the group, so that the convenience is deteriorated.

Since the theme classification information is obtained in the display device after a text set is obtained and divided to obtain a group, the theme classification information does not exist at a point of time at which the text set is obtained. For this reason, a user must read the respective texts to know the outline of the text set. This is very inconvenient.

### SUMMARY OF THE INVENTION

In order to solve the above problem, according to the first aspect of the present invention, there is provided a document processing device for processing a set having, as elements, a plurality of documents including character information, including a theme information generating unit for extracting the commonality of the character information of the respective documents in the set to generate theme information which is a document expressing common semantic contents being common in the entire set.

According to the second aspect of the present invention, there is provided a document processing method for processing a set having, as elements, a plurality of documents including character information, wherein a theme information generating unit extracts the commonality of the character information of the respective documents in the set to generate theme information which is a document expressing common semantic contents being common in the entire set.

### BRIEF DESCRIPTION OF THE DRAWINGS

FIG. 1 is a schematic diagram showing an entire configuration of a browsing system according to an embodiment.

FIG. 2 is a flow chart showing an operation of the embodiment.

FIG. 3 is a display screen showing an operation of the embodiment.

FIG. 4 is a schematic diagram showing contents of a text information storing table used in the embodiment.

FIG. 5 is a schematic diagram showing contents of a text information storing table used in the embodiment.

FIG. 6 is a display screen showing an operation of the embodiment.

FIG. 7 is a display screen showing an operation of the embodiment.

FIG. 8 is a display screen showing an operation of the embodiment.

### DETAILED DESCRIPTION THE PREFERRED EMBODIMENTS

Embodiments will be described below with reference to a case in which a document processing method and device according to the present invention is applied to a browsing system including a search engine.

(Configuration of First Embodiment)

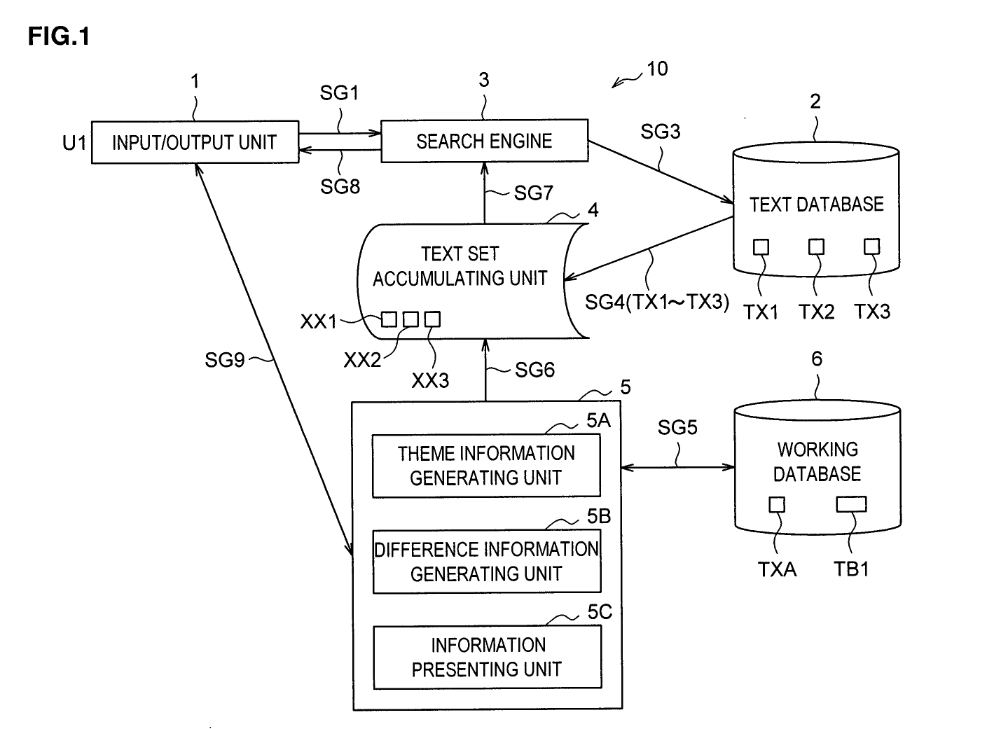

An entire configuration of a browsing system 10 according to this embodiment is shown in FIG. 1. Constituent elements 1 to 5 of FIG. 1 may be arranged in an intranet or one information processing device. However, in this case, the description will be performed on the assumption that the constituent elements are separately arranged on the Internet.

In FIG. 1, the browsing system 10 comprises an input/output unit 1, a text database 2, a search engine 3, a text set accumulating unit 4, a text processing unit 5, and a working database 6.

The input/output unit 1 of these elements is a part corresponding to a communication terminal operated by a user U1 who uses the browsing system 10. As hardware, the input/output unit 1 corresponds to a personal computer or the like having, e.g., a pointing device such as a keyboard or a mouse, a display device, a hard disk drive, a memory, and the like. As hardware, the input/output unit 1 can correspond to a browser installed in the personal computer.

As a browser, a Web browser for browsing Web pages is will known. However, a simple browser indicates not only a Web browser but also all software having a function of browsing some information.

The search engine 3 is a part for executing full text search on the basis of one keyword or a plurality of keywords supplied from the input/output unit 1 depending on an operation of the user U1.

The full text search means an operation for searching all character strings in a document for a target character string. Therefore, for example, when a Web page on which the contents of newspapers are described is searched for, all character strings in an HTML file constituting the Web page are searched.

The full text search function may be installed in a personal computer having the input/output unit 1 if necessary. However, on the Web (WWW), a search service which has been provided by a dedicated search service trader can be used.

The text database 2 is a database in which a large number of texts are stored by using a storage device such as a hard disk or an optical disk. In this case, the texts are equivalent to a document. The document includes not only text data of a text form (data of a plane text form) but also image data of GIF, JPEG, or the like. In general, since one Web page can be constituted by one basic HTML file (as a data form, the HTML form is one of text forms) and one image file or a plurality of image files, the Web page can correspond to the document.

In this sense, the text database 2 can be regarded as one Web server or a plurality of Web servers which provide various Web pages.

Since a search service trader on the Web targets Web pages in the world, the text database 2 can also be regarded as the Web (World Wide Web) itself constituted by a vast number of Web pages (Web servers) separately arranged in the world.

As a matter of course, since the text database 2 is a database for storing texts (documents), a document (e.g., a document described in XML, the text database 2 may include a document described in a data form for electronic publishing such as PDF, or the like) except for a Web page.

In the HTML form, an information sender cannot easily designate the positions and sizes of characters, colorific expressive power is poorer than that of a normal paper (magazine and book and the like). For this reason, many publications on the Internet use the PDF form or the like on which the will of the sender cannot be faithfully reflected. A document described in the PDF form cannot be browsed by the function of only a conventional Web browser. For this reason, when the input/output unit 1 has only the conventional Web browser, plug-in software for expanding the function of the Web browser must be installed in the input/output unit 1.

When a file of described in a data form such as the PDF form which is different from a normal text form is converted into a file of the text form before the file is targeted for search, the file can be easily targeted for search performed by the search engine 3.

Characters may also be described as image data. However, when these characters are converted into data of a text form, the converted data can be target for search performed by the search engine 3.

The text processing unit 5 is a part for processing a plurality of documents obtained as a result of search performed by the search engine 3 using the keyword. The processed documents are accumulated in the text set accumulating unit 4. In this embodiment, it is assumed that a plurality of documents having similar contents are obtained as the result of search performed by the search engine 3. More specifically, for example, newspaper articles and the like which are related to the same case, which have different dates, and which are obtained by a newspaper publisher can correspond to a plurality of documents having similar contents.

In general, for one searching operation, when the number of keywords supplied to the search engine 3 is large, or when respective keywords are characteristic or have identifiability, the contents of a plurality of documents obtained as a result of the searching operation tend to be similar to each other. Since the number of documents obtained as the result of the searching operation is an accidental event which cannot be easily predicted, two or more documents may not be obtained. However, when the number of documents stored in the text database 2 is sufficiently large, a plurality of documents are obtained in many cases.

In this embodiment, the plurality of documents having similar contents and obtained as a result of search by the search engine 3 are considered to constitute one text set (document set), and the text set is targeted for the process of the text processing unit 5. In relation to the terms of Reference 1, the text set is not the group, and is a concept corresponding to the text set.

(Internal Configuration of Text Processing Unit)

As shown in FIG. 1, the text processing unit 5 comprises a theme information generating unit 5A, a difference information generating unit 5B, and an information presenting unit 5C.

Of these units, the theme information generating unit 5A is a part for generating theme information on the basis of the contents of all documents in one text set. The theme information is a document having contents which are sufficient to show the theme of the text set. The theme of the text set is, basically, expressed by a document having contents being common in all the documents in one text set.

For example, when one text set TXG1 is constituted by three documents TX1 to TX3, theme information TH1 of the text set TXG1 can be expressed as a sentence having contents being common in all the documents TX1 to TX3.

Methods for expressing the theme information TH1 in this embodiment are roughly classified into two methods. One of the two methods is a method (summary generating method) for generating a new document TXA serving as the summary of the documents TX1 to TX3 on the basis of the contents of the documents TX1 to TX3 to express the theme information TH1 by the document (summary) TXA, and the other is a method (representation selecting method) for selecting an appropriate document from the documents TX1 to TX3 to express the theme information TH1 by the selected document (for example, TX3) itself.

As methods of realizing the summary generating method, various methods such as a method for detecting paragraphs being common in the documents TX1 to TX3, for example, and combining the detected paragraphs to generate the summary TXA can be used. However, as an example, a method described in the following Reference 2 can also be used.

Reference 2: Columbia Multi-document Summarization: Approach and Evaluation

K. R. McKeown, R. Barzilay, D. Evans, V. Hatzivassiloglou, M. Y. Kan, B. Schiffman, S. Teufel DUC'01

Various methods for realizing the representation selecting method can also be used. For example, the following method can be used. That is, expressions (frequent expressions) which frequently appear being common in the documents TX1 to TX3 are extracted, and a document (for example, TX3) which includes the frequent expressions the number of which is the largest is selected from the documents TX1 to TX3 to select as a representation.

The difference information generating unit 5B is a part which extracts a difference between documents (When the summary generating method is used, TX1 to TX3. When the representation selecting method is used, two documents (e.g., TX1 and TX2) except for a document selected as a representation) corresponding to the theme information TH1. When a unit which includes the frequent expressions is set as common information being common in documents, and when a unit which does not include the frequent expressions is set as unique information unique to the documents, the difference (difference information) is extracted as the unique information. In this case, the unit denotes a grammatical unit such as a clause, a sentence, and a paragraph.

After the difference is extracted, by the attribute of a tag of a mark-up language, it can be designated that the unit corresponds to the difference between the documents.

For example, when the mark-up language is of the XML form (as data form, the XML form is one type of text forms), the unit is sandwiched between a start tag and an end tag, and, by an attribute described in the start tag, it can be described that the unit corresponds to the difference. In this case, as needed, in the difference information generating unit 5B, data form conversion from HTML or the like into XML is executed. In order to designate that the unit corresponds to the difference and store a document in a form such that the document can be recycled, except for a case in which a document on the text database 2 is an XML document and has tags and an attribute which have been defined, a new tag or a new attribute must be defined. The XML form which allows these definitions must be used.

Documents obtained by converting the documents TX1 to TX3 in the XML form are written as documents XX1 to XX3. The document XX1 of the XML form corresponds to the document TX1, the document XX2 of the XML form corresponds to the document TX2, and the document XX3 of the XML form corresponds to the document TX3.

The XML document indicates only the logical structure of the document by using a tag. For this reason, in order to actually define a display method (appearance (i.e., style) when the user U1 browses the documents) of the respective XML documents XX1 to XX3 in the input/output unit 1, a concrete display method must be defined by using a style sheet language.

The information presenting unit 5C is a part which processes the theme information TH1 obtained by the theme information generating unit 5A, the XML documents XX1 to XX3 obtained by the difference information generating unit 5B, and the like into information and documents of a predetermined display form suitable for display by the browser of the input/output unit 1 to present the information and the documents to the user U1.

Therefore, a display method using the style sheet language may also be defined by the information presenting unit 5C.

The concrete display method is determined in advance, and a style sheet language corresponding to the display method is added to the information presenting unit 5C. In this manner, when the theme information TH1 and the XML documents XX1 to XX3 are given to the information presenting unit 5C, the information and the documents can be automatically processed into information and documents in the display form.

The text set accumulating unit 4 is a storage device for accumulating the XML documents XX1 to XX3 concretely defined by the display method using the style sheet language. As the text set accumulating unit 4, some storage area of a hard disk or the like mounted on a communication terminal having the input/output unit 1 may be used. However, a storage server held by a provider for providing on-line storage service on the Internet can also be used.

In any cases, the processes performed in the theme information generating unit 5A, the difference information generating unit 5B, and the information presenting unit 5C are considered to correspond to alternation of the documents (in this case, TX1 to TX3) which are literary works. From the viewpoint of copyright protection, the documents XX1 to XX3 which are results of the processes are desirably stored in a form in which the documents cannot be browsed by persons except for the user U1.

Although the text processing unit 5 may be mounted on the communication terminal having the input/output unit 1, the text processing unit 5 may be arranged as a server on the Internet.

The working database 6 is a database in which the data such as the documents TX1 to TX3 are arranged and stored to cause the constituent elements 5A to 5C in the text processing unit 5 to perform the process. Finally, the documents XX1 to XX3 are obtained and accumulated in the text set accumulating unit 4, and the storage contents in the working database 6 can be discarded.

In order to cause the user U1 to correctly browse the XML documents XX1 to XX3, the browser of the input/output unit 1 must be a browser coping with the XML. When the browser installed in the input/output unit 1 is a browser such as a normal Web browser which does not cope with the XML, a function coping with the XML is given to the input/output unit 1 by using plug-in software.

The plug-in software is statically installed in the input/output unit 1 in advance, and the plug-in software can also be dynamically installed in the input/output unit 1 through the Internet.

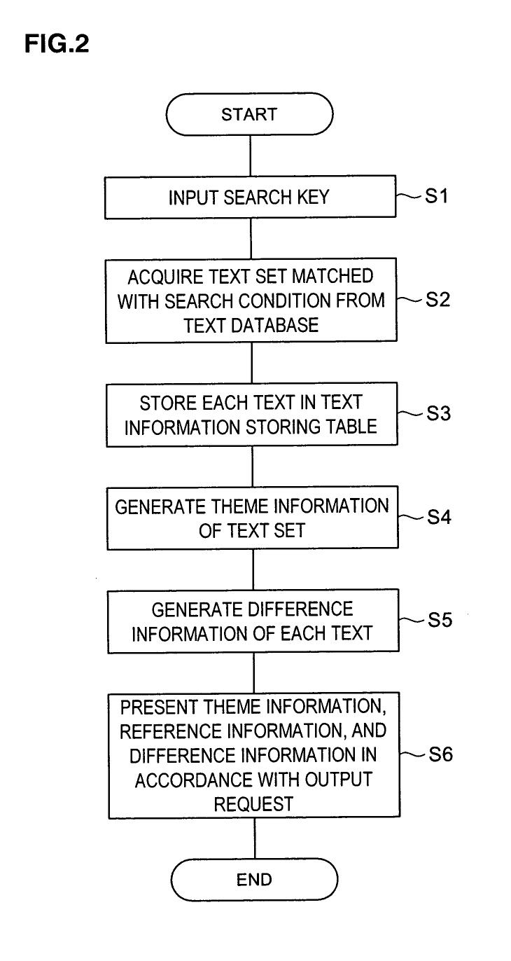

An operation of this embodiment having the configuration will be described below with reference to the flow chart in FIG. 2.

The flow chart in FIG. 2 is constituted by steps S1 to S6.

(Operation of Embodiment)

When the user U1 accesses the search engine 3 by using the browser of the input/output unit 1 to supply a desired search condition (S1), the search engine 3 searches the text database 2 for a document adapted to the search condition (S2).

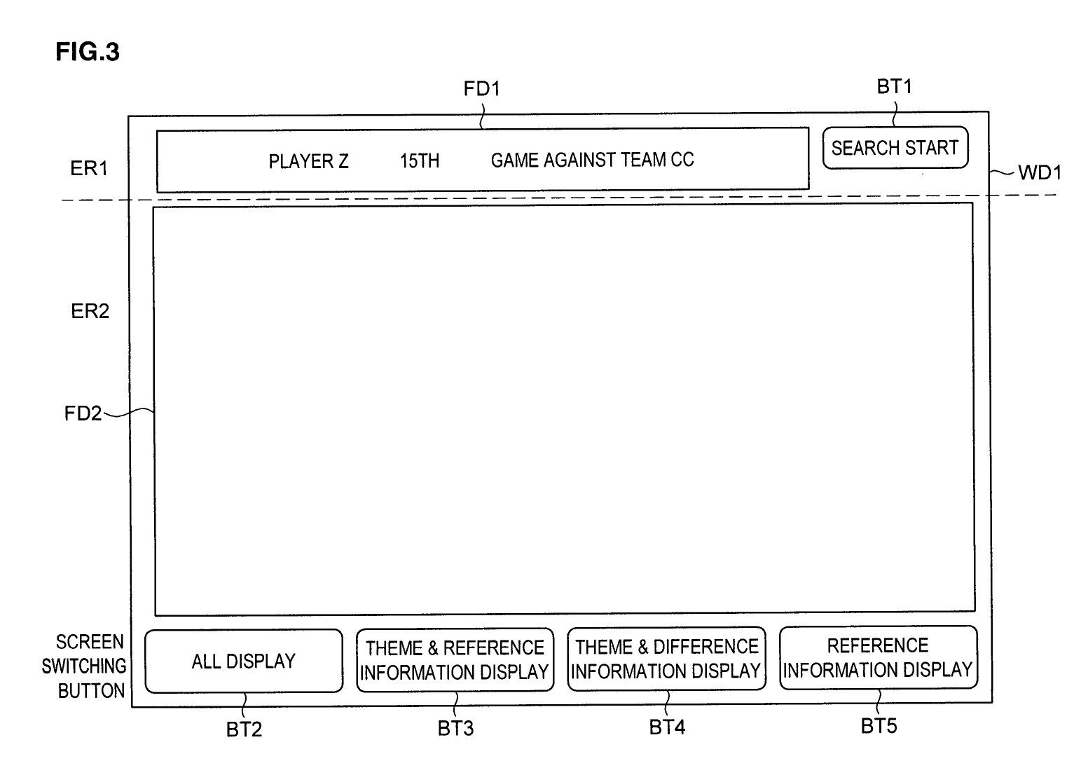

When step S1 is executed, a screen displayed on the browser in the input/output unit 1 may be, e.g., a screen shown in FIG. 3.

In FIG. 3, a window WD1 constituting the screen is divided into an input area ER1 for receiving an input from the user U1 and an output area ER2 for basically returning an output to the user U1. A field FD1 and a button BT1 are arranged in the input area ER1, and a field FD2 and screen switching buttons BT2 to BT5 are arranged in an output area ER2.

Of these elements, the field FD1 is a search key input unit for receiving an input of the search key by the user U1. In this case, as the search key, a plurality of keywords including a date are allowed to be input. However, if necessary, various search conditions such as the range of a date on which documents are formed (for example, documents formed on and after Jun. 11, 2002 are searched) can be flexibly and exactly designated.

When the contents of the search key input to the search key input unit FD1 are fixed, and when the user U1 operates the “search start” button BT1, the search key is supplied to the search engine 3 to execute the search. In the example in FIG. 3, three keywords, i.e., “player Z” (name of a baseball player), “15th”, and “game against team CC” are input to the search key input unit FD1.

It is assumed that, as search results corresponding to the three keywords, the three documents TX1 to TX3 are obtained.

In this embodiment, the documents TX1 to TX3 serving as the search results are not displayed in a field (search result output unit) FD2, and a result of the process performed by the text processing unit 5 is displayed in the field FD2. For this reason, the result is displayed in the field FD2 after the processes in the subsequent steps S3 to S6 are executed.

The three documents XT1 to XT3 obtained as the result of the search performed by the search engine 3 are stored in a text information storing table TB1 in the working database 6 in step S3.

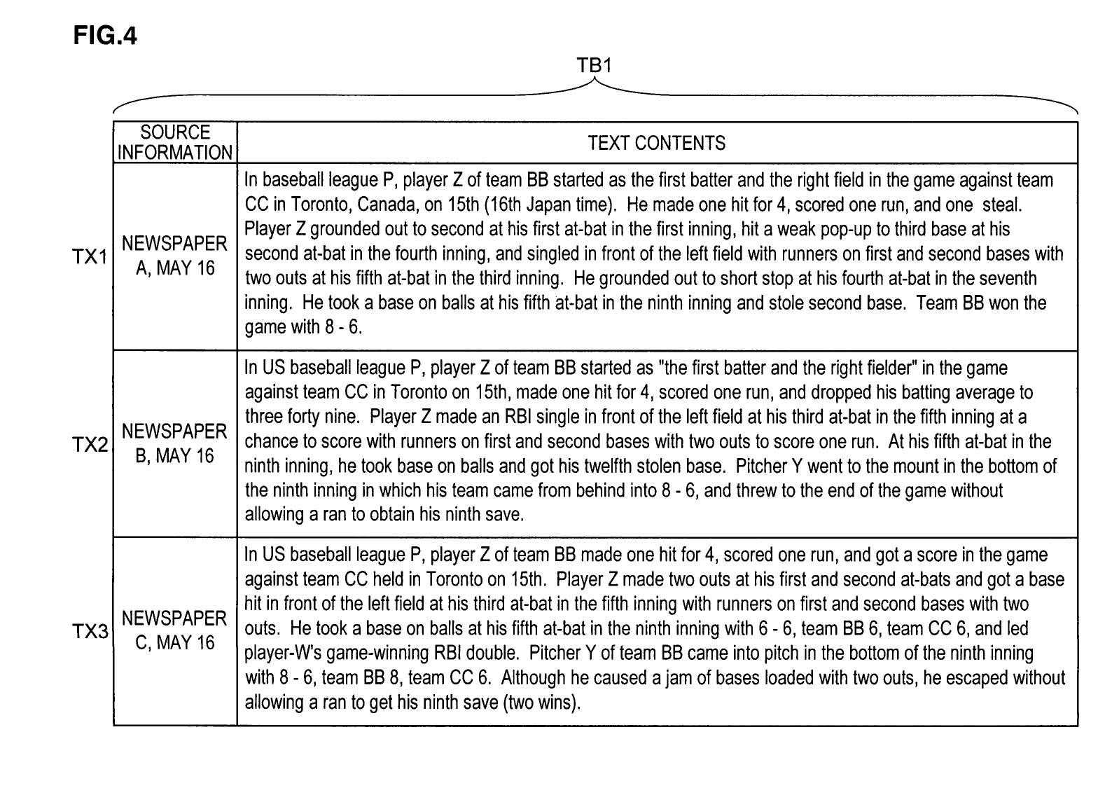

The storage contents of the text information storing table TB1 are, e.g., the storage contents shown in FIG. 4.

In FIG. 4, the text information storing table TB1 is constituted by two string names (attributes), i.e., “source information” and “text contents”.

Since the number of documents TX1 to TX3 obtained by the search performed by the search engine 3 is 3, the number of tuples of the text information storing table TB1 is also 3.

In the example shown in FIG. 4, as the source information, the name and the date of a newspaper serving as the source of the documents TX1 to TX3 are described. This is an example of off-line source information which can be read by human being and used in community at large except for a network. If necessary, in place of the off-line source information, or together with the off-line source information, on-line source information may also be described. As the on-line source information, information which uniquely designates a position where the documents TX1 to TX3 exist on the text database 2, for example, URL, FQDN, and IP addresses and the like can be used.

As is apparent from the text contents in FIG. 4, these documents TX1 to TX3 are newspaper articles of the same date which report fine showings by the player Z in a game in which team BB to which a baseball player Z (outfielder) belongs to matches team CC in the US baseball league P. Therefore, the text contents which are the contents of the documents TX1 to TX3 are almost equal to each other. For example, the documents have the following different point therebetween. That is, although the document TX2 which is the article of newspaper B describes player Z dropped his batting average to three forty nine, the document TX1 which is the article of newspaper A and the document TX3 which is the article of newspaper C do not describe that the batting average was dropped.

The theme information generating unit 5A generates the theme information TH1 on the basis of the storage contents of the text information storing table TB1 (S4).

In this case, it is assumed that the theme information TH1 is generated by using the summary generating method selected from the methods including the summary generating method and the representation selecting method described above.

The summary TXA generated by the summary generating method is stored in the working database 6 together with the text information storing table TB1 until the process in at least the text processing unit 5 is ended. As a matter of course, if necessary, a string name for storing the contents of the summary TXA may be prepared in the text information storing table TB1.

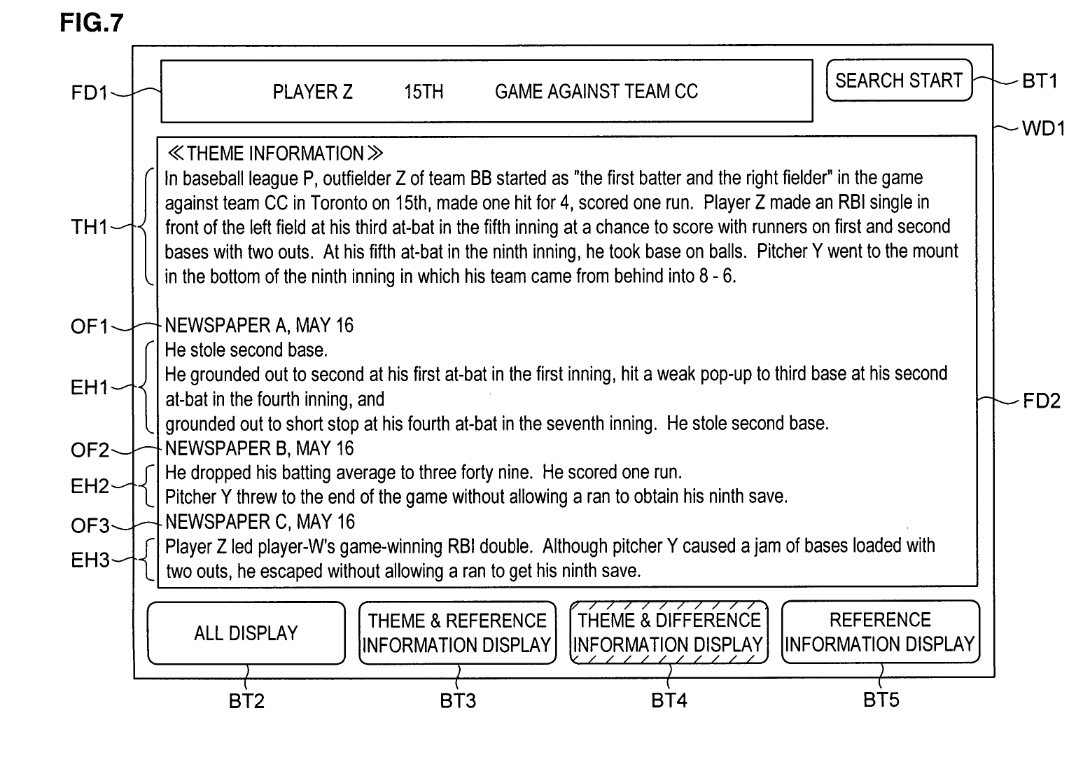

Thereafter, difference information between the documents TX1 to TX3 and the summary TXA is extracted (S5). At this time, since a clause is used as the unit, conversion of the documents TX1 to TX3 into documents in the XML form, storage of the converted XML documents XX1 to XX3 into the text set accumulating unit 4, and the like are performed, and contents displayed on the search result output unit FD2 on the input/output unit 1 depending on an output request from the user U1 are shown in, e.g., FIG. 7.

In the search result output unit FD2 in FIG. 7, the theme information TH1 is displayed at the highest part, one blank line is arranged therebelow, and “newspaper A on May 16” which is off-line source information OF1 and difference information EH1 corresponding to the theme information TH1 of the article of newspaper A on May 16, “newspaper B on May 16” which is off-line source information OF2 and difference information EH2 corresponding to the theme information TH1 of the article of newspaper B on May 16, and “newspaper C on May 16” which is off-line source information OF3 and difference information EH3 corresponding to the theme information TH1 of the article of newspaper C on May 16 are displayed.

A process of extracting only difference information (EH1 in this case) from a document (for example, XX1) to display a screen as shown in FIG. 7 can be executed by the function of a browser (or a browser equipped with the plug-in software) for the XML form on the input/output unit 1 such that it is designated for the attribute of the tag that the units correspond to the differences.

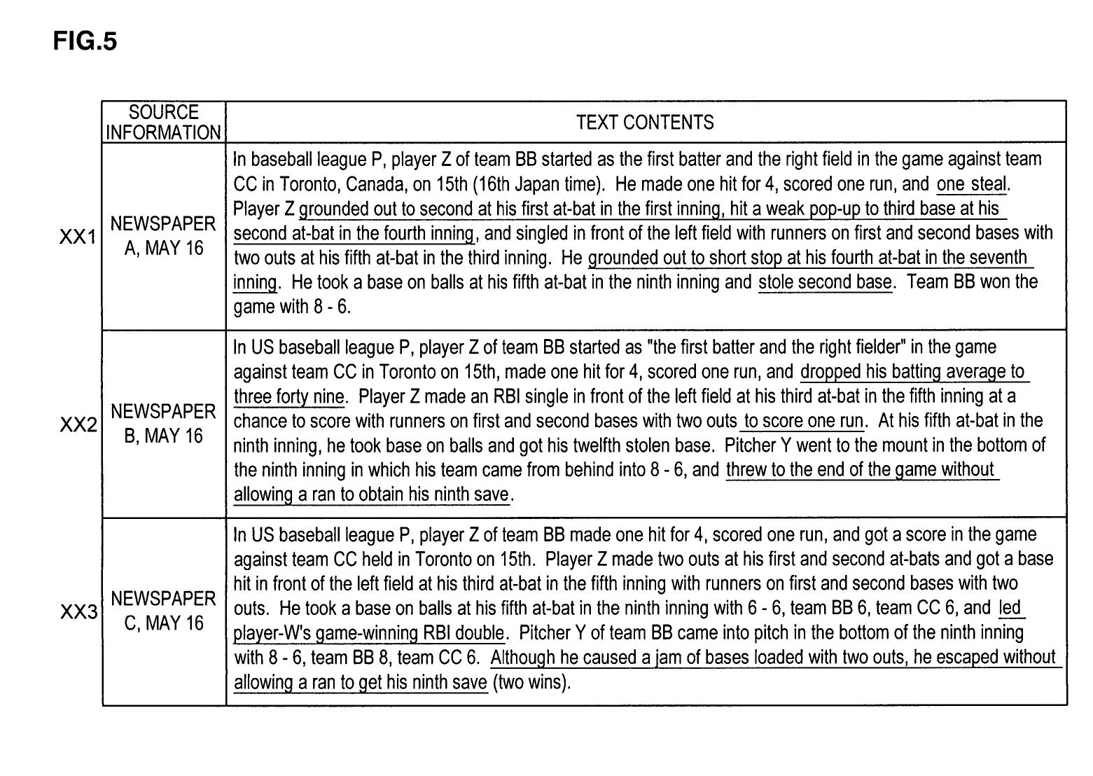

The differences corresponding to the differences between the documents XX1 to XX3 are parts which are underlined in FIG. 5.

When the screen in FIG. 7 is displayed on the input/output unit 1, the user U1 can correctly recognize the theme of the text set by reading the theme information TH1 without reading the contents of the respective documents XX1 to XX3. Since the number of characters of the theme information TH1 is almost equal to the number of characters of one arbitrary document of the documents XX1 to XX3, the number of characters to be read by the user U1 is about ⅓ the number of characters read when the respective documents XX1 to XX3, and the difference and the similarity between the article contents of the documents XX1 to XX3 need not be analyzed by using the intellectual power of the user U1. Operations for downloading the files of the respective documents XX1 to XX3 to the input/output unit 1 and opening the files need not be performed one by one.

For this reason, the user U1 very easily recognizes the theme information TH1. These effects are generally conspicuous as the number of documents of one text set increase.

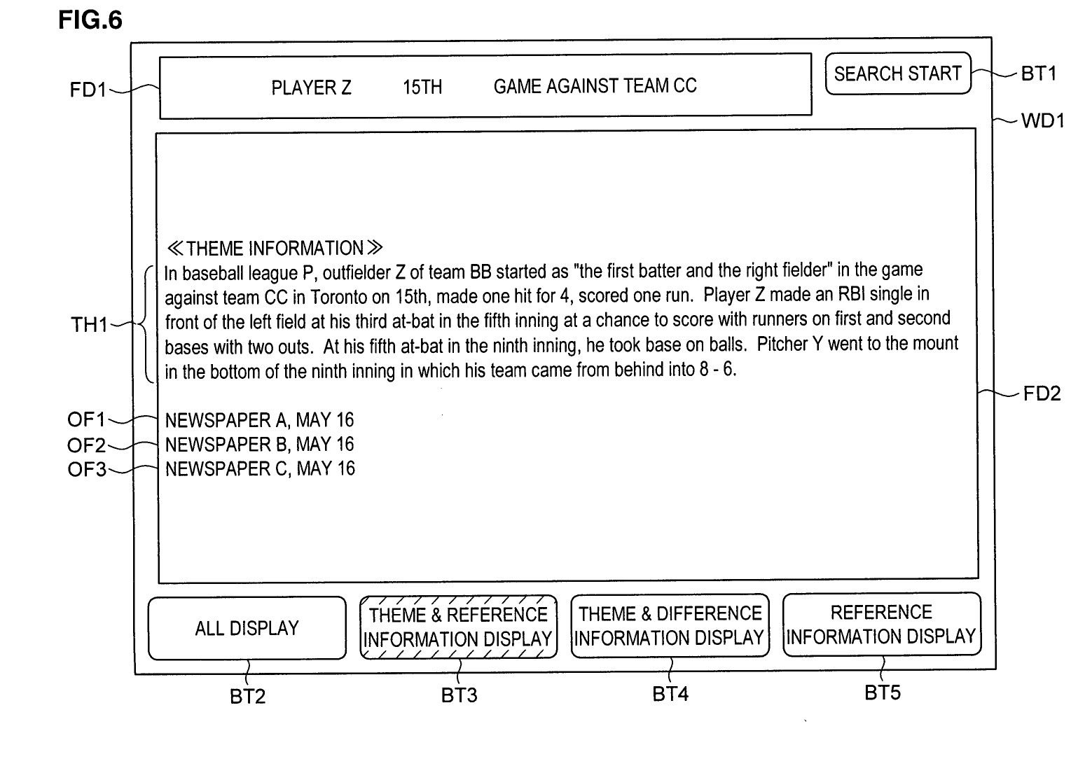

The screen in FIG. 7 is a display screen corresponding to a case in which the user U1 makes an output request by operating a “theme & difference information display” button BT4. When the user U1 makes an output request by operating a “theme & reference information display” button BT3, a screen is displayed as shown in FIG. 6. This reference information is equal to the source information.

In FIG. 6, the pieces of difference information EH1 to EH3 are erased, and only the off-line source information OF1 to OF3 are displayed below the theme information TH1.

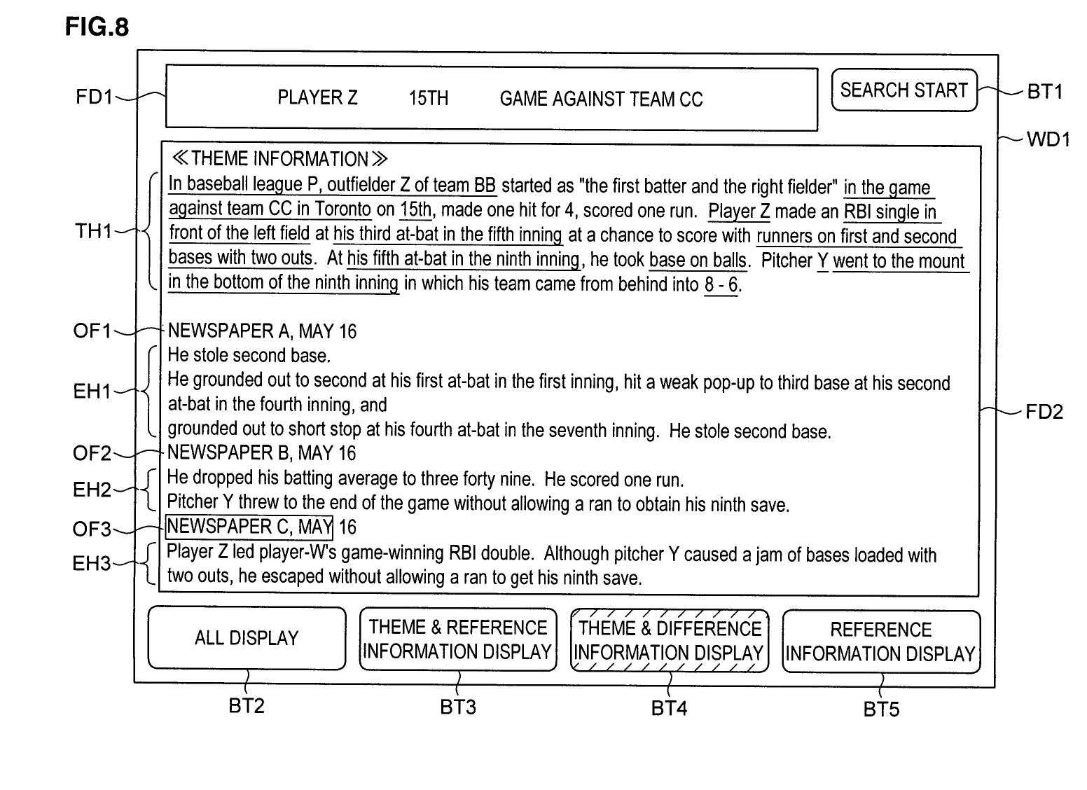

On the other hand, FIG. 8 shows a display obtained when the user U1 selects the off-line source information OF3 by using a pointing device or the like on the display screen in FIG. 7.

At this time, on the theme information TH1, an underline is displayed at every position, and, of the contents of the theme information TH1, specific information obtained from the document TX3 corresponding to the off-line source information OF3 can be intuitively shown. Similarly, when the user U1 selects the off-line source information OF2, an underline is drawn to shows information obtained from the document TX2 corresponding to the off-line source information OF2 in the contents of the theme information TH1. When the user U1 selects the off-line source information OF 1, an underline is drawn such that information obtained by the document TX1 corresponding to the off-line source information OF1 in the contents of the theme information TH1.

If necessary, even on the screen in FIG. 6, an underline may be similarly drawn by selecting off-line source information.

This underline can be properly changed into a reversing display or a hatched display by changing the style sheet language. A layout or the like on the search result output unit FD2 in FIGS. 6 to 8 changes depending on a change in style sheet language.

Even though any one of the screens in FIGS. 6 to 8 are visually checked, the user U1 can easily and reliably recognize the theme of a text set constituted by the documents TX1 to TX3 (or XX1 to XX3) by reading the theme information TH1.

If necessary, when the pieces of off-line source information OF1 to OF3 and the documents XX1 to XX3 (or documents TXl to TX3 on the text database 2) are related to each other, all the sentences of the documents can be also be displayed when the off-line source information is selected.

(Effect of Embodiment)

According to this embodiment the user (U1) can conveniently recognize the theme (e.g., TH1) of the text set without reading the respective documents (e.g., TX1 to TX3) included in the text set.

In this embodiment, pieces of difference information (e.g., EH1 to EH3) between the documents and the theme can be displayed, and a specific part (unit) of the theme information corresponding to the documents can be displayed. For this reason, the user is assisted to compare the documents with each other and analyze the documents.

(Another Embodiment)

Regardless of the embodiment, as a communication terminal of the input/output unit 1, in place of a general personal computer having a pointing device or the like, a touch-panel device can be used, or a dedicated communication terminal can be used.

As has bee described above, the documents TX1 to TX3 and the documents XX1 to XX3 may include not only simple text data but also image data or the like.

In the embodiment, the text processing unit 5 finally converts documents into data in the XML form (or a text form) to accumulate the data in the text set accumulating unit 4. However, if necessary, the documents may be converted into date in a data form except for the XML form (text form) as a matter of course.

In addition, in the embodiment, depending on the tag and the attribute of XML, it is designated that the unit corresponds to a difference, and the unit is stored such that the unit can be recycled. However, these functions may be realized by using a method except for the method using the tag and the attribute of XML.

In this embodiment, when the theme information TH1 is generated, the summary generating method or the representation selecting method is used as described above. However, the theme information may be generated by a method except for the above methods.

For example, theme information may automatically determine the theme information by a predetermined typical procedure (for example, a document having the smallest number of characters is simply selected as theme information from a plurality of searched documents (e.g., TX1 to TX3).

From the beginning, when the degrees of similarity between the documents TX1 to TX3 are sufficiently high in the search operation performed by the search engine 3, the theme of the text set can also be preferably expressed by the document which is selected by such a simple method.

In addition, in this embodiment, the user U1 cannot concern herself/himself in the process of generating theme information, the theme information is automatically generated by the text processing unit 5. However, the theme information can also be generated depending on the will of the user U1.

For example, it may be designed that one arbitrary document in the text set can also be selected by the user U1 as theme information.

In this case, depending on the selection of the user U1, the text processing unit 5 operates to automatically obtain difference information or the like between one document selected by the user U1 and another document. Such a configuration is effective when common points or different points between a plurality of similar documents must be exactly sorted.

Regardless of the embodiment, the search engine 3 can be omitted.

On the phase of actual document processing, in many cases, a plurality of documents (e.g., TX1 to TX3) are given in advance without a search operation by the search engine 3. In addition, the documents (e.g., TX1 to TX3) may not necessarily supplied through a network. For example, the documents may be supplied as documents stored in a recording medium such as a floppy disk or a CD-ROM, or may be obtained such that documents supplied as paper media are loaded into a system through an OCR process or the like.

In the embodiment, since the newspaper articles of the same date which report fine showings by baseball player Z in a game held by the same date are used, it can be clearly predicted that the contents of the documents TX1 to TX3 are similar to each other. However, the present invention can also be applied to a plurality of documents the similarity of which is not known.

In this case, use of the present invention can make it possible to perform an operation of deciding the degree of similarity between documents.

The scheme of the text information storing table TB1 used in the above embodiment is not limited to the table described above. A string name in the text information storing table TB1 may be replaced with another string name, and a string name which is not included in the text information storing table TB1 may be added to the text information storing table TB1. If necessary, such a text information storing table may be normalized as a matter of course.

In addition, the working database 6 and the text set storing unit 4 need not be independently arranged as hardware, and can be integrated with each other.

Regardless of the embodiment, the input/output unit 1 can be omitted.

For example, the following system can also be used. That is, a search operation by the search engine 3 and processing by the text processing unit 5 are performed according to a program or the like which is given in advance, and documents (e.g., XX1 to XX3) serving as final results are written on a recording medium to complete the processes.

In the embodiment, the concrete display screens are shown in FIGS. 3, 6 to 8. However, the configurations of display screens according to the present invention are not limited to the illustrated display screens as a matter of course.

Further more, although the newspaper articles are used as the documents TX1 to TX3, documents targeted by the present invention are not limited to newspaper articles as a matter of course.

In the above embodiment, the present invention is mainly realized as software. However, the present invention can also be realized as hardware.

As has been described above, the document processing method and device according to the present invention is better than a conventional document processing method and device in convenience.

What is claimed is:

1. A document processing device for processing a set having, as elements, a plurality of documents including character information, comprising:
a theme information generating unit for extracting the commonality of the character information of the respective documents in the set to generate theme information which is a document expressing common semantic contents being common in the entire set.

2. A document processing device according to claim 1, wherein
the theme information generating unit executes a predetermined generating procedure on the basis of the plurality of documents in the set to generate the theme information as a new document.

3. A document processing device according to claim 2, wherein
the theme information generating unit extracts an expression being common in the plurality of documents in the set and generates the theme information on the basis of the expression.

4. A document processing device according to claim 1, wherein
the theme information generating unit selects documents having a commonality in character information in advance to constitute the set, selects one document from the plurality of documents in the set depending on a predetermined selecting procedure, and sets the selected document as the theme information to generate the theme information.

5. A document processing device according to claim 4, wherein
in the selecting procedure, frequent expressions which appear times the number of which is not less than a predetermined threshold value in the documents in the set are detected, and a document which includes the frequent expressions the number of which is largest is selected.

6. A document processing device according to claim 1, comprising
a difference character information generating unit for generating difference character information serving as character information serving as differences between the theme information and the documents in the set.

7. A document processing device according to claim 6, comprising:
an information presenting unit for displaying a document obtained by the theme information generating unit; and
a text set accumulating unit for accumulating the documents processed into documents of a predetermined display form suitable for display on the information presenting unit, wherein
the information presenting unit displays that the difference character information is differences between the theme information and the documents in the set.

8. A document processing device according to claim 7, wherein
the information presenting unit displays the theme information and difference character information between the theme information and the documents on a screen depending on an operation by a user.

9. A document processing device according to claim 8, wherein
the information presenting unit displays source information representing an on-line or off-line source of a document including the difference character information on a screen depending on an operation by the user.

10. A document processing device according to claim 9, wherein
when the user performs a predetermined operation to the source information displayed on the screen, the information presenting unit executes predetermined identification display for identifying difference character information between a document corresponding to the source information and the theme information to the theme information displayed on the screen.

11. A document processing method for processing a set having, as elements, a plurality of documents including character information, wherein
a theme information generating unit extracts the commonality of the character information of the respective documents in the set to generate theme information which is a document expressing common semantic contents being common in the entire set.

12. A document processing method according to claim 11, wherein
the theme information generating unit executes a predetermined generating procedure on the basis of the plurality of documents in the set to generate the theme information as a new document.

13. A document processing method according to claim 12, wherein
the theme information generating unit extracts an expression being common in the plurality of documents in the set and generates the theme information on the basis of the expression.

14. A document processing method according to claim 11, wherein
the theme information generating unit selects documents having a commonality in character information in advance to constitute the set, selects one document from the plurality of documents in the set depending on a predetermined selecting procedure, and sets the selected document as the theme information to generate the theme information.

15. A document processing method according to claim 14, wherein
in the selecting procedure, frequent expressions which appear times the number of which is not less than a predetermined threshold value in the documents in the set are detected, and a document which includes the frequent expressions the number of which is largest is selected.

16. A document processing method according to claim 11, wherein
difference character information serving as character information serving as differences between the theme information and the documents in the set is generated.

17. A document processing method according to claim 16, comprising:
an information presenting unit for displaying a document obtained by the theme information generating unit displays that the difference character information is differences between the theme information and the documents in the set.

18. A document processing method according to claim 17, wherein
the information presenting unit displays the theme information and difference character information between the theme information and the documents on a screen depending on an operation by a user.

19. A document processing method according to claim 18, wherein
the information presenting unit displays source information representing an on-line or off-line source of a document including the difference character information on a screen depending on an operation by the user.

20. A document processing method according to claim 19, wherein
when the user performs a predetermined operation to the source information displayed on the screen, the information presenting unit executes predetermined identification display for identifying difference character information between a document corresponding to the source information and the theme information to the theme information displayed on the screen.
